(19) United States
(12) Patent Application Publication
(10) Pub. No.: US 2025/0088292 A1
(43) Pub. Date: Mar. 13, 2025

(54) WIRELESS APPARATUS AND WIRELESS COMMUNICATION METHOD

(71) Applicant: NIPPON TELEGRAPH AND TELEPHONE CORPORATION, Tokyo (JP)

(72) Inventors: Hanae OTANI, Musashino-shi (JP); Kengo NAGATA, Musashino-shi (JP); Akira KISHIDA, Musashino-shi (JP); Shoko SHINOHARA, Musashino-shi (JP); Yusuke ASAI, Musashino-shi (JP); Yasushi TAKATORI, Musashino-shi (JP)

(73) Assignee: NIPPON TELEGRAPH AND TELEPHONE CORPORATION, Tokyo (JP)

(21) Appl. No.: 18/728,586

(22) PCT Filed: Jan. 28, 2022
(86) PCT No.: PCT/JP2022/003348

§ 371 Date: Jul. 12, 2024

(51) Int. Cl. H04B 17/309; H04L 1/00; H04W 72/542

(52) U.S. Cl. CPC H04B 17/309; H04L 1/0003; H04W 72/542

(57) ABSTRACT

A wireless apparatus according to one aspect of the present invention includes an acquisition unit configured to acquire a communication quality index indicating communication quality of a link for each of a plurality of links forming a multi-link with another wireless apparatus; and a multi-link control unit configured to determine whether to suspend use of a first link having the lowest communication quality among the plurality of links based on comparison between the communication quality index for the first link and a first threshold.

### CROSS-REFERENCE TO RELATED APPLICATION

This application is a national stage application, pursuant to 35 U.S.C. § 371, of International Patent Application No. PCT/JP2022/003348, filed Jan. 28, 2022, the entire contents of which are incorporated herein by reference.

### TECHNICAL FIELD

The present invention relates to wireless communication.

### BACKGROUND ART

A wireless local area network (LAN) is known as a wireless communication system that wirelessly connects a access point and a terminal. The access point and the terminal as wireless stations of the wireless LAN perform carrier sense based on carrier sense multiple access with collision avoidance (CSMA/CA), and transmit data when a transmission right is acquired.

A multi-link operation under consideration in IEEE 802.11be being formulated as a successor standard to IEEE 802.11ax enables the terminal to establish a plurality of links with the access point. In the case where the plurality of links is established, the wireless station performs carrier sense based on CSMA/CA for each link, and transmits a data frame, using the link for which the transmission right has been acquired. The multi-link operation provides improved throughput and latency characteristics.

Meanwhile, in a case where a hidden terminal is present, or the like, even if the wireless station transmits the frame, using the link for which the transmission right has been acquired, a collision may occur between the frame transmitted by the wireless station and a frame transmitted by another wireless station that cannot be detected by the wireless station. Such a frame collision deteriorates the communication characteristics of multi-link communication.

### CITATION LIST

### Non Patent Literature

Non Patent Literature 1: IEEE P802.11be/D1.2, “35.3.6 Link management”, September 2021.

### SUMMARY OF INVENTION

### Technical Problem

An object of the present invention is to provide a technique for preventing deterioration of communication characteristics of multi-link communication.

### Solution to Problem

A wireless apparatus according to one aspect of the present invention includes an acquisition unit configured to acquire a communication quality index indicating communication quality of a link for each of a plurality of links forming a multi-link with another wireless apparatus, and a multi-link control unit configured to determine whether to suspend use of a first link having the lowest communication quality among the plurality of links based on comparison between the communication quality index for the first link and a first threshold.

### Advantageous Effects of Invention

According to the present invention, there is provided a technique for preventing deterioration of communication characteristics of multi-link communication.

### BRIEF DESCRIPTION OF DRAWINGS

FIG. 1 is a diagram illustrating a communication system according to an embodiment.

FIG. 2 is a conceptual diagram illustrating frequency bands used in the wireless communication according to the embodiment.

FIG. 3 is a diagram illustrating link management information according to the embodiment.

FIG. 4 is a diagram illustrating a wireless network according to the embodiment.

FIG. 5 is a block diagram illustrating a hardware configuration of a access point according to the embodiment.

FIG. 6 is a block diagram illustrating a functional configuration of the access point according to the embodiment.

FIG. 7 is a diagram illustrating a channel access function of a link management unit according to the embodiment.

FIG. 8 is a block diagram illustrating a hardware configuration of a terminal according to the embodiment.

FIG. 9 is a block diagram illustrating a functional configuration of the terminal according to the embodiment.

FIG. 10 is a flowchart illustrating multi-link setup processing according to the embodiment.

FIG. 11 is a flowchart illustrating multi-link control according to the embodiment.

FIG. 12 is a flowchart illustrating multi-link control according to the embodiment.

FIG. 13 is a flowchart illustrating multi-link control according to the embodiment.

FIG. 14 is a flowchart illustrating multi-link control according to the embodiment.

FIG. 15 is a flowchart illustrating multi-link control according to the embodiment.

FIG. 16 is a flowchart illustrating multi-link control according to the embodiment.

### DESCRIPTION OF EMBODIMENTS

Hereinafter, embodiments of the present invention will be described with reference to the drawings.

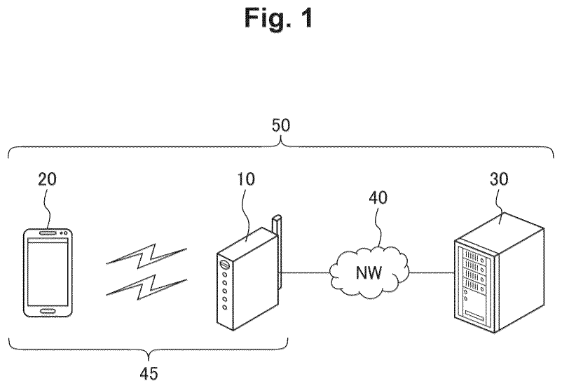

FIG. 1 schematically illustrates a configuration example of a communication system 50 including a wireless network 45 according to an embodiment. The “system” and “network” described in the present specification may be interchangeably used. As illustrated in FIG. 1, the communication system 50 includes a access point 10, a terminal 20, and a server 30. The access point 10 and the terminal 20 are included in the wireless network 45.

The access point 10 operates as an access point (AP) of a wireless LAN. The access point 10 can be wirelessly connected to one or a plurality of terminals. The number of terminals wirelessly connected to the access point 10 dynamically changes. In the example illustrated in FIG. 1, the access point 10 is wirelessly connected to the terminal 20. The access point 10 establishes one or a plurality of links with the terminal 20, and wirelessly communicates with the terminal 20 by using the one or the plurality of links. In the present specification, wireless connection using the plurality of links between the access point and the terminal is referred to as “multi-link”. The access point 10 is connected to a communication network 40, which may include the Internet, by wire, for example.

The terminal 20 is a wireless terminal device having a wireless communication function. Examples of the wireless terminal device include smart phones, mobile phones, tablet personal computers (PCs), desktop PCs, laptop PCs, and Internet of things (IoT) sensors/devices. The terminal 20 exchanges data with a computer such as the server 30 on the communication network 40 via the access point 10.

The server 30 is connected to the communication network 40. For example, the server 30 may be a service provider that provides a service such as cloud gamming, and exchanges data related to the service with the terminal 20 via the communications network 40.

In the wireless network 45, the wireless communication between the access point 10 and the terminal 20 is based on the IEEE 802.11 standard. Although the wireless communication based on the IEEE 802.11 standard is described as an example in the present specification, a wireless communication standard different from the IEEE 802.11 standard may be used.

The IEEE 802.11 standard defines a first layer and a media access control (MAC) sublayer in a second layer of an open systems interconnection (OSI) model. In the OSI model, a communication function is divided into seven layers (a first layer: a physical layer, a second layer: a data link layer, a third layer: a network layer, a fourth layer: a transport layer, a fifth layer: a session layer, a sixth layer: a presentation layer, a seventh layer: an application layer). The data link layer includes, for example, a logical link control (LLC) layer and a MAC layer. The LLC layer adds a destination service access point (DSAP) header, a source service access point (SSAP) header, and the like to data input from a higher-level layer to generate an LLC packet, for example. The MAC layer adds a MAC header to the LLC packet to generate a MAC frame, for example. The physical layer adds a preamble, a physical layer (PHY) header, and the like to the MAC frame to generate a wireless frame, for example. Here, processing for the first layer and the MAC sublayer in the second layer defined by the IEEE 802.11 standard will be mainly described, and description of processing for other layers is omitted.

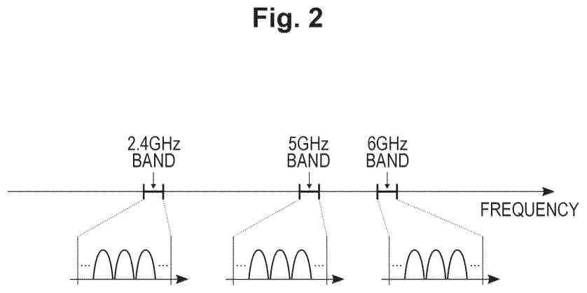

FIG. 2 schematically illustrates frequency bands used in the wireless network 45. In the example illustrated in FIG. 2, three frequency bands of a 6 GHz band, a 5 GHz band, and a 2.4 GHz band are available in the wireless communication between the access point 10 and the terminal 20. Each frequency band includes a plurality of channels. In the present embodiment, the multi-link is formed by using channels of different frequency bands. For example, three links using a channel of the 6 GHz band, a channel of the 5 GHz band, and a channel of the 2.4 GHz band may be established between the access point 10 and the terminal 20. In other embodiments, a plurality of channels included in the same frequency band may be used to form a multi-link.

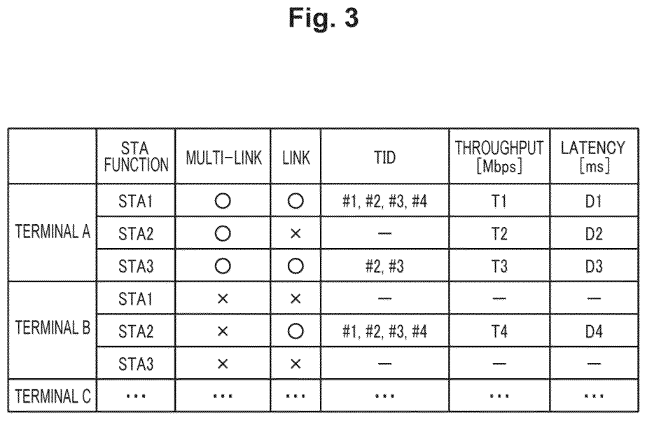

FIG. 3 schematically illustrates a link management table as link management information held by the access point 10. The link management information is information for managing a link state related to each terminal wirelessly connected to the access point 10. In the example illustrated in FIG. 3, the link management table includes information of STA function, multi-link, link, traffic identifier (TID), throughput, and latency.

The STA function corresponds to a wireless signal processing unit that processes a wireless signal. In the present embodiment, the access point 10 includes three wireless signal processing units: a wireless signal processing unit configured to transmit and receive a wireless signal using the channel of the 6 GHz band; a wireless signal processing unit configured to transmit and receive a wireless signal using the channel of the 5 GHz band; and a wireless signal processing unit configured to transmit and receive a wireless signal using the channel of the 2.4 GHz band. In FIG. 3, STA1 represents the wireless signal processing unit that uses the channel of the 6 GHz band, STA2 represents the wireless signal processing unit that uses the channel of the 5 GHz band, and STA3 represents the wireless signal processing unit that uses the channel of the 2.4 GHz band.

The multi-link information includes information indicating whether a multi-link is established between the access point 10 and the terminal, and information indicating which link is established in the case where the multi-link is established. The link information includes information indicating whether a link is used for data transmission. In the example illustrated in FIG. 3, regarding a terminal A, the multi-link information indicates that a multi-link is established between the access point 10 and the terminal A, and three links corresponding to STA1, STA2, and STA3 are established. The link information indicates that the links corresponding to STA1 and STA3 are used for data transmission, and the link corresponding to STA2 is not used for data transmission. In other words, the links corresponding to STA1 and STA3 are in an active state, and the link corresponding to STA2 is in a suspension state (an inactive state). Regarding a terminal B, the multi-link information indicates that a multi-link is not established between the access point 10 and the terminal B. The link information indicates that the link corresponding to STA2 is used for data transmission. That is, a single link is established between the access point 10 and the terminal B. The terminal B may be a legacy terminal that does not support the multi-link operation.

The TID is an identifier indicating a type of traffic (data). Each of the STA functions transmits and receives traffic of the TID assigned to oneself. The traffic is classified into a plurality of access categories. In one example, the traffic may be classified into four access categories of “Voice (VO)”, “Video (VI)”, “Best Effort (BE)”, and “Background (BK)”. In another example, the traffic may be classified into five access categories of “VO”, “VI”, “BE”, “BK”, and “Low Latency (LL)”. Traffic of the access category “LL” is latency-sensitive traffic, such as traffic originating from a real-time application such as cloud gaming. For example, the traffic of TID #1 is classified into the access category “VO”, the traffic of TID #2 is classified into the access category “VI”, the traffic of TID #3 is classified into the access category “BE”, and the traffic of TID #4 is classified into the access category “BK”. In the example illustrated in FIG. 3, regarding the terminal A, TID #1 is allocated to STA1, TID #2 is allocated to STA1 and STA3, TID #3 is allocated to STA1 and STA3, and TID #4 is allocated to STA1. In other words, STA1 is used to transmit and receive the traffic of TID #1 to TID #4, and STA3 is used to transmit and receive the traffic of TID #2 and TID #3. Regarding the terminal B, the single link corresponding to STA2 is established, and TID #1 to TID #4 are allocated to STA2.

The link corresponding to the STA function is associated with the TID when the multi-link between the access point 10 and the terminal is established. For example, in association between a TID and a link (TID-to-link mapping), each TID may be associated with all of links. Alternatively, the association between a TID and a link may be set such that a traffic amount (data amount) becomes equal among the plurality of links forming the multi-link. Alternatively, traffic of types similar to each other may be associated with a specific link. A frequency band allocated to transmission and reception of traffic is favorably selected in accordance with the type and the data amount of the traffic. For example, it is conceivable that voice (VO) with a small data amount is associated with the 2.4 GHz band and video (VI) with a large data amount is associated with the 5 GHz band.

The access point 10 measures (monitors) the throughput and the latency related to data transmission between the access point 10 and the terminal for each terminal and for each link (STA function), and registers measured values in the link management table. In FIG. 3, symbols (T1, D1, and the like) are described in columns of the throughput and the latency, but specific numerical values are actually stored.

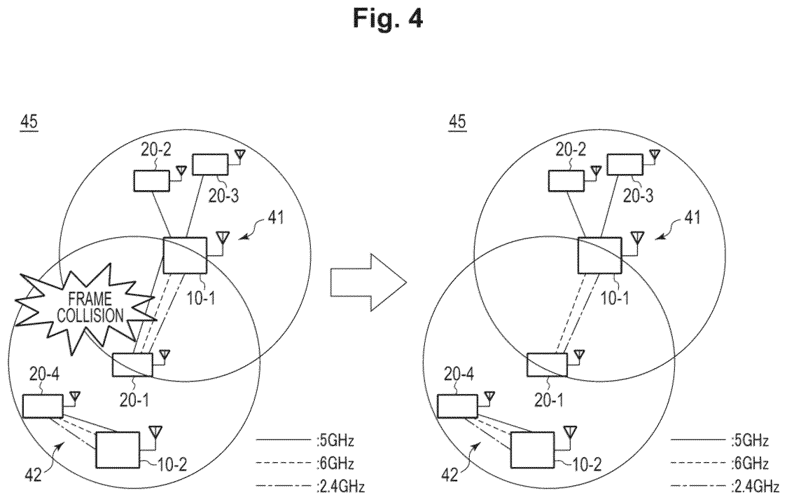

FIG. 4 schematically illustrates an arrangement example of the wireless stations included in the wireless network 45. In the example illustrated in FIG. 4, the wireless network 45 includes basic service sets (BSSs) 41 and 42. The BSS 41 includes a access point 10-1 and terminals 20-1, 20-2, and 20-3. A multi-link is established between the access point 10-1 and the terminal 20-1, and the multi-link includes three links corresponding to the 6 GHz band, the 5 GHz band, and the 2.4 GHz band. The terminals 20-2 and 20-3 are legacy terminals, and a single link corresponding to the 5 GHz band is established between the access point 10-1 and each of the terminals 20-2 and 20-3. The BSS 42 includes a access point 10-2 and a terminal 20-4. A multi-link is established between the access point 10-2 and the terminal 20-4, and the multi-link includes three links corresponding to the 6 GHz band, the 5 GHz band, and the 2.4 GHz band.

The access point 10-2 and the terminal 20-4 are hidden terminals for the access point 10-1. Therefore, a situation may occur in which the access point 10-1 transmits a frame to the terminal 20-1 on the link of the 5 GHz band, and at the same time, the access point 10-2 or the terminal 20-4 transmits a frame to the terminal 20-4 or the access point 10-2 on the link of the 5 GHz band. In this case, a frame collision occurs at the terminal 20-1, and the terminal 20-1 may fail to receive the frame from the access point 10-1. The frame collision leads to a decrease in throughput and/or an increase in latency, and communication characteristics of the multi-link communication between the access point 10-1 and the terminal 20-1 are deteriorated.

Furthermore, in a case where a request to send (RTS)/clear to send (CTS) function is used for communication between the access point 10-1 and the terminal 20-1, the terminal 20-1 sets a network allocation vector (NAV) period for the link of the 5 GHz band in response to detection of an RTS frame or a data frame transmitted by the access point 10-2 or the terminal 20-4 on the link of the 5 GHz band. Even when receiving the RTS frame from the access point 10-1, the terminal 20-1 does not transmit a CTS frame to the access point 10-1 during the NAV period. In a case where the access point 10-1 fails to receive the CTS frame from the terminal 20-1, the RTS frame is retransmitted. Although the use of the RTS/CTS function can effectively prevent the above-described frame collision, there may be many situations in which retransmission of the RTS frame is required. As described above, even when the RTS/CTS function is used, the communication characteristics of the multi-link communication between the access point 10-1 and the terminal 20-1 may deteriorate.

Furthermore, in a case where there are many legacy terminals that use only a link corresponding to a specific frequency band (the 5 GHz band in the example of FIG. 4) such as the terminals 20-2 and 20-3, contention for the link corresponding to the specific frequency band increases. The throughput is decreased and/or latency is increased for the link corresponding to the specific frequency band. As a result, the communication characteristics of the multi-link communication between the access point 10-1 and the terminal 20-1 deteriorate.

In the present embodiment, the access point 10-1 measures, for each terminal and for each link, a packet error rate (PER) corresponding to a communication quality index indicating communication quality of the link. The access point 10-1 determines a link in which the measured value of PER exceeds a predetermined threshold as a link in which many frame collisions occur, and suspends use of this link. In the example illustrated in FIG. 4, the access point 10-1 suspends the use of the link of the 5 GHz band established between the access point 10-1 and the terminal 20-1, and as illustrated in the right part of FIG. 4, the access point 10-1 and the terminal 20-1 communicate with each other by using the link of 6 GHz and the link of 2.4 GHz. By avoiding the use of the link of 5 GHz that has been determined to be the link in which many frame collisions occur, it is possible to prevent deterioration of the communication characteristics of the multi-link communication between the access point 10-1 and the terminal 20-1.

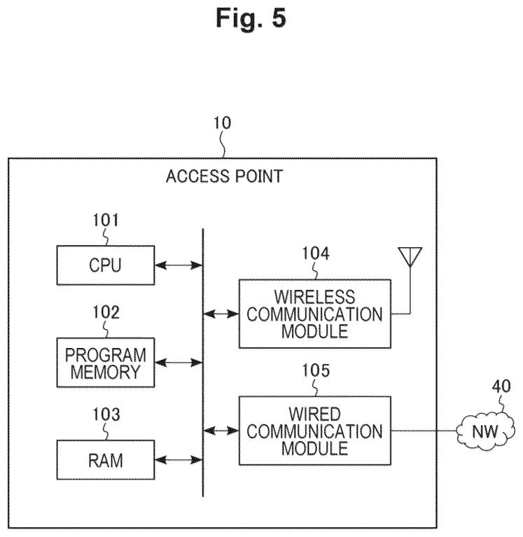

FIG. 5 schematically illustrates a hardware configuration example of the access point 10. As illustrated in FIG. 5, the access point 10 includes, for example, a central processing unit (CPU) 101, a program memory 102, a random access memory (RAM) 103, a wireless communication module 104, and a wired communication module 105.

The CPU 101 is an integrated circuit capable of executing various programs and controls an operation of the entire access point 10. The program memory 102 is a nonvolatile semiconductor memory such as a read only memory (ROM) or a flash memory, and stores a program for controlling the access point 10, control data, and the like. The RAM 103 is, for example, a volatile semiconductor memory, and is used as a working area for the CPU 101. The wireless communication module 104 is a circuit used to transmit/receive data by a wireless signal, and is connected to an antenna. The wireless communication module 104 includes a plurality of communication modules respectively corresponding to a plurality of frequency bands. The wired communication module 105 is a circuit used to transmit/receive data by a wired signal, and is connected to the communication network 40.

The hardware configuration illustrated in FIG. 5 is an example, and the access point 10 may have a hardware configuration different from that illustrated in FIG. 5. For example, in a case where the access point 10 is wirelessly connected to the communication network 40, the wired communication module 105 may be omitted from the access point 10.

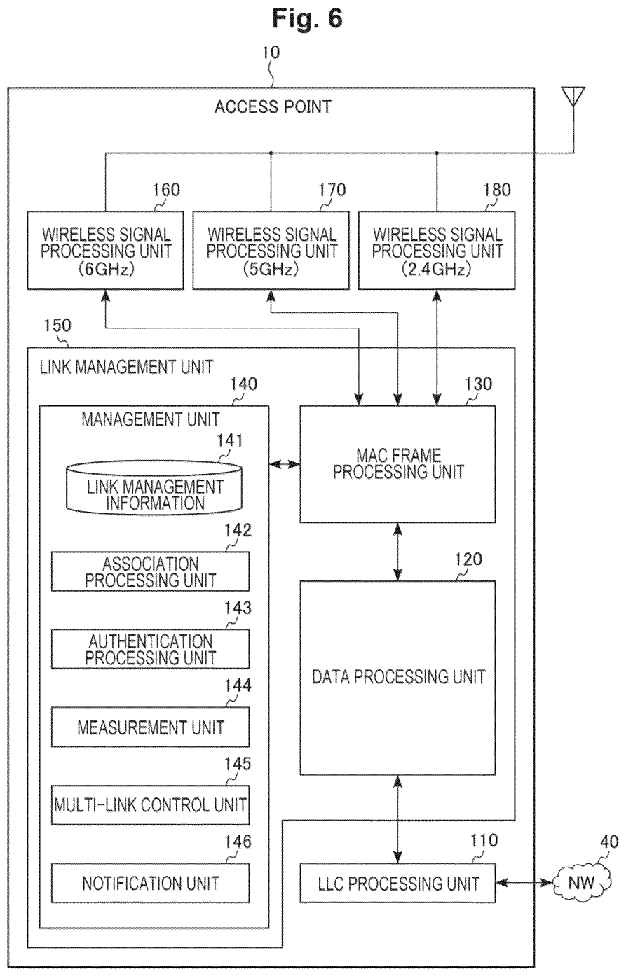

FIG. 6 schematically illustrates a functional configuration example of the access point 10. As illustrated in FIG. 6, the access point 10 includes an LLC processing unit 110, a link management unit 150, and wireless signal processing units 160, 170, and 180. The LLC processing unit 110 may be implemented by a combination of the CPU 101 and the wired communication module 105. A data processing unit 120, a MAC frame processing unit 130, the link management unit 150, and the wireless signal processing units 160, 170, and 180 may be implemented by the wireless communication module 104 or a combination of the wireless communication module 104 and the CPU 101.

The LLC processing unit 110 executes processing of the LLC layer and processing of the higher-level layer (third layer to seventh layer) for input data. For example, the LLC processing unit 110 adds a DSAP header, an SSAP header, and the like to data received from a computer (for example, the server 30 illustrated in FIG. 1) on the communication network 40 to generate an LLC packet, and sends the LLC packet to the link management unit 150. Furthermore, the LLC processing unit 110 receives an LLC packet from the link management unit 150, extracts data from the LLC packet, and transmits the data to the computer on the communication network 40.

The link management unit 150 performs the processing of the MAC layer on the input data. Further, the link management unit 150 manages the link with each terminal wirelessly connected to the access point 10. The link management unit 150 includes the data processing unit 120, the MAC frame processing unit 130, and a management unit 140.

The data processing unit 120 receives an LLC packet from the LLC processing unit 110, and adds the MAC header to the LLC packet to generate the MAC frame. Then, data processing unit 120 sends the MAC frame to the MAC frame processing unit 130. In addition, the data processing unit 120 receives a MAC frame from the MAC frame processing unit 130 and extracts the LLC packet from the MAC frame. Then, the data processing unit 120 sends the LLC packet to the LLC processing unit 110.

The MAC frame processing unit 130 receives a MAC frame that is a data frame from the data processing unit 120, and temporarily stores the MAC frame. Then, the MAC frame processing unit 130 performs carrier sense to confirm the situation of the channel corresponding to the link associated with the TID of the data included in the MAC frame. In a case where the channel is busy, the MAC frame processing unit 130 continues the carrier sense. In a case where the channel is idle, the MAC frame processing unit 130 sends the MAC frame to the wireless signal processing unit corresponding to the link associated with the TID of the data included in the MAC frame. The MAC frame processing unit 130 receives a MAC frame that is a management frame or a control frame from the management unit 140, and sends the MAC frame to any one of the wireless signal processing units 160, 170, and 180.

Further, the MAC frame processing unit 130 receives MAC frames from the wireless signal processing units 160, 170, and 180, and sends the MAC frames to the data processing unit 120 or the management unit 140 according to the type of the MAC frames. For example, in a case where the MAC frames are data frames, the MAC frame processing unit 130 sends the MAC frames to data processing unit 120. In a case where the MAC frames are management frames or control frames, the MAC frame processing unit 130 sends the MAC frames to management unit 140. Moreover, the MAC frame processing unit 130 executes processing based on an instruction of the management unit 140, and exchanges information with the management unit 140.

The management unit 140 manages the links to the terminals on the basis of information included in the management frames received from the wireless signal processing units 160, 170, and 180 via the MAC frame processing unit 130. In one example, the management unit 140 includes link management information 141, an association processing unit 142, an authentication processing unit 143, a measurement unit 144, a multi-link control unit 145, and a notification unit 146.

The link management information 141 includes information of the terminal wirelessly connected to the access point 10. The link management information 141 is stored in, for example, the RAM 103 and is referred to by the MAC frame processing unit 130. For example, the MAC frame processing unit 130 uses the link management information 141 to specify the link corresponding to the TID of the data included in the MAC frame to be transmitted. In a case where the link management information 141 includes the information illustrated in FIG. 3, TID #1 is associated with the link corresponding to STA1 (that is, the wireless signal processing unit 160) for the terminal A. When receiving the MAC frame including the data addressed to the terminal A with TID #1 from the data processing unit 120, the MAC frame processing unit 130 sends the MAC frame to the wireless signal processing unit 160.

The association processing unit 142 executes a protocol related to an association in a case of receiving a connection request from the terminal via any of the wireless signal processing units 160, 170, and 180. The authentication processing unit 143 executes a protocol related to authentication subsequent to the association.

The measurement unit 144 measures at least one type of index related to the communication quality or performance of the link. Some of the indexes may be statistics. The at least one type of index to be measured includes a communication quality index representing the communication quality of the link. The measurement unit 144 measures the communication quality index for each terminal and each link. The communication quality index may include at least one of a PER, a collision rate divided by airtime, or a retransmission rate of request to send (RTS). The PER represents a ratio of frames that fails to be received by the terminal to frames transmitted by the access point 10 to the terminal. The collision rate represents a rate at which a frame transmitted from the access point 10 to the terminal collides with a frame transmitted from another wireless station (for example, another terminal and/or another access point) at the terminal. Airtime represents a total time in which the channel (link) is used to transmit the frame to the terminal. The RTS retransmission rate represents a rate at which the RTS frame is retransmitted from the access point 10 to the terminal.

The at least one type of index to be measured may further include the throughput and the latency related to data transmission between the access point 10 and the terminal. The measurement unit 144 measures the throughput and the latency for each terminal and for each link. The at least one type of index to be measured may further include an Ack response rate. The Ack response rate represents a ratio of Ack frames received from the terminal by the access point 10 to the frames transmitted to the terminal by the access point 10. The Ack frame is a frame used for acknowledgment of frame reception. The measurement unit 144 measures the Ack response rate for each terminal and for each link. The at least one type of index to be measured may further include a reception success probability of a dummy frame. The dummy frame is a data frame including dummy data, and is used to determine whether to resume use of the link in the suspension state. The reception success probability of the dummy frame represents a probability that the terminal successfully receives the dummy frame transmitted by the access point 10.

The multi-link control unit 145 controls the use of a plurality of links forming a multi-link for each terminal. The multi-link control unit 145 performs multi-link control on the basis of the measurement result of at least one type of index obtained by the measurement unit 144. The multi-link control includes processing of suspending the use of the links, processing of resuming the use of the links, and association between the TID and the links accompanying suspension or resumption of the use of the links. For example, in a case where the PER of a certain link of a certain terminal exceeds a predetermined threshold, the multi-link control unit 145 suspends the use of the link. For example, in a case where the total throughput is not improved after suspending the use of the link, the multi-link control unit 145 resumes the use of the link. Furthermore, for example, the multi-link control unit 145 includes a transmission unit that transmits the dummy frame to the terminal by using the link in the suspension state, the measurement unit 144 measures the reception success probability of the dummy frame, and the multi-link control unit 145 resumes use of the link in response to the reception success probability of the dummy frame exceeding a predetermined threshold.

Moreover, the multi-link control unit 145 executes association between the TID and the link. The association between the TID and the link is performed when, for example, the multi-link is established between the access point 10 and the terminal.

The notification unit 146 notifies the terminal of multi-link control information for controlling the use of the plurality of links forming the multi-link. In one example, the multi-link control information is generated by the multi-link control unit 145, and includes information indicating the link to suspend or resume the use. The multi-link control information may be transmitted to the terminal with a management frame (for example, a beacon). In another example, the multi-link control information includes the measurement result obtained by the measurement unit 144.

The wireless signal processing unit 160 transmits and receives data between the access point 10 and the terminal by wireless communication. Specifically, the wireless signal processing unit 160 executes physical layer processing for the input data or wireless signal. For example, the wireless signal processing unit 160 receives a MAC frame from the MAC frame processing unit 130, and adds the preamble, the PHY header, and the like to the MAC frame to generate the wireless frame. Then, the wireless signal processing unit 160 performs a predetermined modulation operation for the wireless frame to convert the wireless frame into a wireless signal, and transmits the wireless signal via an antenna. The predetermined modulation operation includes convolutional coding, interleaving, subcarrier modulation, inverse fast Fourier transform (IFFT), orthogonal frequency division multiplexing (OFDM) modulation, and frequency transform, for example. Further, the wireless signal processing unit 160 receives a wireless signal from the terminal via the antenna, and performs a predetermined demodulation operation for the received wireless signal to obtain the wireless frame. The predetermined demodulation operation includes frequency transform, OFDM demodulation, fast Fourier transform (FFT), subcarrier demodulation, deinterleaving, and Viterbi decoding, for example. Then, the wireless signal processing unit 160 extracts a MAC frame from the wireless frame, and transmits the MAC frame to MAC frame processing unit 130.

The wireless signal processing units 170 and 180 perform processing similar to the wireless signal processing unit 160. Therefore, description of the wireless signal processing units 170 and 180 is omitted. In the present example, the wireless signal processing units 160, 170, and 180 handle the wireless signals of the 6 GHz band, the 5 GHz band, and the 2.4 GHz band, respectively. Note that the wireless signal processing units 160, 170, and 180 may use a common antenna or may use individual antennas.

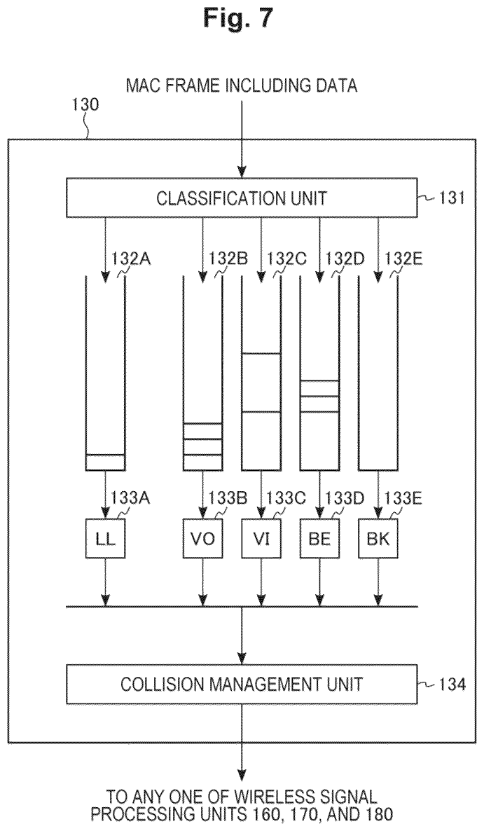

FIG. 7 schematically illustrates a channel access function of the MAC frame processing unit 130. As illustrated in FIG. 7, the MAC frame processing unit 130 includes a classification unit 131, transmission queues 132A, 132B, 132C, 132D, and 132E, carrier sense execution units 133A, 133B, 133C, 133D, and 133E, and a collision management unit 134.

The classification unit 131 classifies the MAC frames received from the data processing unit 120 and inputs the MAC frame to the transmission queues 132A, 132B, 132C, 132D, and 132E. In the example illustrated in FIG. 7, the classification unit 131 classifies the MAC frames into the five access categories “LL”, “VO”, “VI”, “BE”, and “BK”, inputs the MAC frame classified into the access category “LL” to the transmission queue 132A, inputs the MAC frame classified into the access category “VO” to the transmission queue 132B, inputs the MAC frame classified into the access category “VI” to the transmission queue 132C, inputs the MAC frame classified into the access category “BE” to the transmission queue 132D, and inputs the MAC frame classified into the access category “BK” to the transmission queue 132E. The transmission queues 132A, 132B, 132C, 132D, and 132E buffer the input MAC frames. The transmission queues 132A, 132B, 132C, 132D, and 132E are implemented by, for example, the RAM 103.

The carrier sense execution units 133A, 133B, 133C, 133D, and 133E execute carrier sense based on CSMA/CA according to access parameters set in advance for the respective units. The access parameter is set for each access category such that transmission of a wireless signal is prioritized in the order of “LL”, “VO”, “VI”, “BE”, and “BK”, for example. The carrier sense execution units 133A, 133B, 133C, 133D, and 133E execute carrier sense for the MAC frames stored in the transmission queues 132A, 132B, 132C, 132D, and 132E, respectively. For example, in a case where the transmission right is acquired (in a case where the channel is idle), the carrier sense execution unit 133A extracts the MAC frame from the transmission queue 132A and outputs the MAC frame to the wireless signal processing unit corresponding to the link associated with the access category “LL” via the collision management unit 134.

The collision management unit 134 prevents a transmission collision in a case where a plurality of carrier sense execution units among the carrier sense execution units 133A, 133B, 133C, 133D, and 133E acquires the transmission right for the same link. The collision management unit 134 gives priority to transmission of data of an access category with a high priority. The access category “LL” has the highest priority. It is assumed that the carrier sense execution unit 133A and one of the carrier sense execution units 133B, 133C, 133D, and 133E simultaneously acquire the transmission right for the link corresponding to the wireless signal processing unit 160. In this case, the collision management unit 134 gives priority to the transmission right acquired by the carrier sense execution unit 133A, and outputs the MAC frame received from the carrier sense execution unit 133A to the wireless signal processing unit 160.

In the embodiment, an example in which the MAC frame processing unit 130 implements the channel access function is described, but the wireless signal processing units 160, 170, and 180 may implement the channel access function.

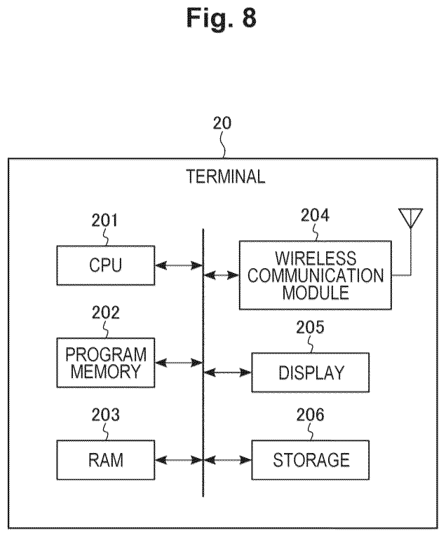

FIG. 8 schematically illustrates a hardware configuration example of the terminal 20. As illustrated in FIG. 8, the terminal 20 includes, for example, a CPU 201, a program memory 202, a RAM 203, a wireless communication module 204, a display 205, and a storage 206.

The CPU 201 is an integrated circuit capable of executing various programs, and controls overall operation of the terminal 20. The program memory 202 is a nonvolatile semiconductor memory such as a ROM, and stores a program for controlling the terminal 20, control data, and the like. The storage 206 may be used as the program memory 202. The RAM 203 is, for example, a volatile semiconductor memory, and is used as a working area for the CPU 201. The wireless communication module 204 is a circuit used to transmit and receive data by a wireless signal and is configured to be connectable to an antenna. Furthermore, the wireless communication module 204 includes, for example, a plurality of communication modules respectively corresponding to a plurality of frequency bands. The display 205 displays information of a graphical user interface (GUI) provided by application software, or the like, for example. The display 205 may have a function as an input interface of the terminal 20. For example, a touch panel may be provided on the display 205. The storage 206 is a nonvolatile storage device, and stores data including system software and the like of the terminal 20, for example.

The hardware configuration illustrated in FIG. 8 is an example, and the terminal 20 may have a hardware configuration different from that illustrated in FIG. 8. For example, in a case where the terminal 20 is an IoT device or the like, the display 205 may be omitted from the terminal 20.

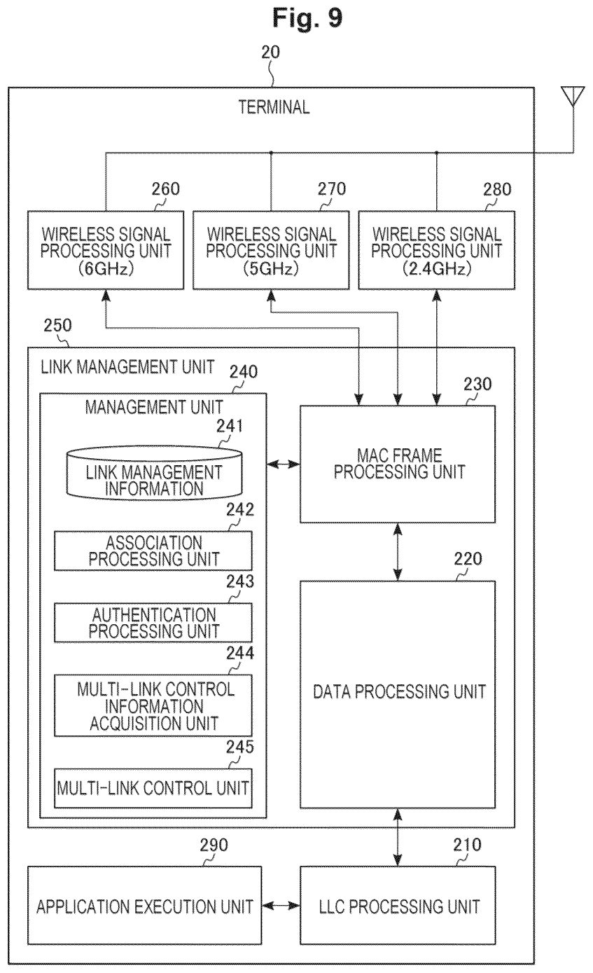

FIG. 9 schematically illustrates a functional configuration example of the terminal 20. As illustrated in FIG. 9, the terminal 20 includes an LLC processing unit 210, a link management unit 250, wireless signal processing units 260, 270, and 280, and an application execution unit 290. The LLC processing unit 210 and the application execution unit 290 may be implemented by the CPU 201. The link management unit 250 and the wireless signal processing units 260, 270, and 280 may be implemented by the wireless communication module 204 or a combination of the wireless communication module 204 and the CPU 201.

The LLC processing unit 210 executes processing of the LLC layer and the higher-level layer for the input data. For example, the LLC processing unit 210 receives data from the application execution unit 290, adds the DSAP header, the SSAP header, and the like to the data to generate the LLC packet, and sends the LLC packet to the link management unit 250. In addition, the LLC processing unit 210 receives an LLC packet from the link management unit 250, extracts data from the LLC packet, and sends the data to the application execution unit 290.

The link management unit 250 executes processing of the MAC layer for the input data. Furthermore, the link management unit 250 manages the link with the access point 10 wirelessly connected to the terminal 20. The link management unit 250 includes a data processing unit 220, a MAC frame processing unit 230, and a management unit 240.

The data processing unit 220 receives an LLC packet from the LLC processing unit 210, and adds the MAC header to the LLC packet to generate the MAC frame. Then, data processing unit 220 transmits the MAC frame to the MAC frame processing unit 230. In addition, the data processing unit 220 receives a MAC frame from the MAC frame processing unit 230 and extracts the LLC packet from the MAC frame. Then, the data processing unit 220 sends the LLC packet to the LLC processing unit 210.

The MAC frame processing unit 230 receives a MAC frame that is a data frame from the data processing unit 220, and temporarily stores the MAC frame. Then, the MAC frame processing unit 230 performs carrier sense to confirm the situation of the channel corresponding to the link associated with the TID of the data included in the MAC frame. In the case where the channel is busy, the MAC frame processing unit 230 continues the carrier sense. In the case where the channel is idle, the MAC frame processing unit 230 sends the MAC frame to the wireless signal processing unit corresponding to the link associated with the TID of the data included in the MAC frame. Since the channel access function of the MAC frame processing unit 230 is similar to the channel access function of the MAC frame processing unit 130 of the access point 10 described with reference to FIG. 7, description of the channel access function of the MAC frame processing unit 230 is omitted.

The MAC frame processing unit 230 receives the MAC frame that is a management frame or a control frame from the management unit 240, and sends the MAC frame to any one of the wireless signal processing units 260, 270, and 280.

Further, the MAC frame processing unit 230 receives MAC frames from the wireless signal processing units 260, 270, and 280, and sends the MAC frames to the data processing unit 220 or the management unit 240 according to the type of the MAC frames. For example, in the case where the MAC frames are data frames, the MAC frame processing unit 230 sends the MAC frames to data processing unit 220. In the case where the MAC frames are management frames or control frames, the MAC frame processing unit 230 sends the MAC frames to management unit 240. Moreover, the MAC frame processing unit 230 executes processing based on an instruction of the management unit 240, and exchanges information with the management unit 240.

The management unit 240 manages the links to the access point 10 on the basis of information (for example, the multi-link control information) included in management frames received from the wireless signal processing units 260, 270, and 280 via the MAC frame processing unit 230. The management unit 240 includes link management information 241, an association processing unit 242, an authentication processing unit 243, a multi-link control information acquisition unit 244, and a multi-link control unit 245.

The link management information 241 includes information of the access point 10 wirelessly connected to the terminal 20. The link management information 241 may include information of the STA function, multi-link, link, TID, throughput, and latency. The link management information 241 may match information related to the terminal 20 included in the link management information 141 of the access point 10. The terminal 20 measures (monitors) the throughput and latency for each terminal and for each link (STA function), and registers measured values in the link management information 241. The link management information 241 is stored in, for example, the RAM 203 and is referred to by the MAC frame processing unit 230. For example, the MAC frame processing unit 230 uses the link management information 241 to specify the link corresponding to the TID of the data included in the MAC frame to be transmitted.

The association processing unit 242 executes a protocol related to an association including transmission of a connection request to the access point 10. The authentication processing unit 243 executes a protocol related to authentication subsequent to the association.

The multi-link control information acquisition unit 244 acquires the multi-link control information from the access point 10, and sends the multi-link control information to the multi-link control unit 245. The management frame including the multi-link control information transmitted by the access point 10 is received by any of the wireless signal processing units 260, 270, and 280 and given to the multi-link control information acquisition unit 244 via the MAC frame processing unit 230. The multi-link control information acquisition unit 244 extracts the multi-link control information from the management frame.

The multi-link control unit 245 controls the use of the plurality of links forming the multi-link between the access point 10 and the terminal 20 on the basis of the multi-link control information. In an example in which the multi-link control information includes information indicating the link to suspend or resume the use, the multi-link control unit 245 controls the use of each link according to the multi-link control information. For example, in a case where the multi-link control information includes information indicating that the use of a certain link is to be suspended, the multi-link control unit 245 specifies the link to suspend the use on the basis of the multi-link control information, and updates the link management information 241 in order to switch the specified link to the suspension state. In an example in which the multi-link control information includes the measurement result of the communication quality index obtained by the measurement unit 144 of the access point 10, the multi-link control unit 245 uses the same algorithm as the multi-link control unit 145 of the access point 10 to control the use of each link on the basis of the measurement result included in the multi-link control information.

Further, the multi-link control unit 245 determines association between the TID and the link. The association between the TID and the link is executed at predetermined timing such as when the multi-link is established between the access point 10 and the terminal 20. For example, at the time of multi-link setup, the multi-link control unit 245 determines the association between the TID and the link, and requests the multi-link control unit 145 of the access point 10 to apply the association. Then, when the terminal 20 receives a positive response to the request from the access point 10, the association between the TID and the link is determined.

Note that the management unit 240 may further include a measurement unit that performs processing similar to the measurement unit 144 (FIG. 6) of the access point 10. In a case where the management unit 240 includes the measurement unit, the measurement result obtained by the measurement unit is notified to the access point 10 and used by the access point 10 to perform multi-link control.

The wireless signal processing unit 260 transmits and receives data between the access point 10 and the terminal 20 by wireless communication. Specifically, the wireless signal processing unit 260 executes physical layer processing for the input data or wireless signal. For example, the wireless signal processing unit 260 receives a MAC frame from the MAC frame processing unit 230, and adds the preamble, the PHY header, and the like to the MAC frame to generate the wireless frame. Then, the wireless signal processing unit 260 performs a predetermined modulation operation for the wireless frame to convert the wireless frame into a wireless signal, and transmits the wireless signal via an antenna. Further, the wireless signal processing unit 260 receives a wireless signal from the access point 10 via the antenna, and performs a predetermined demodulation operation for the received wireless signal to obtain the wireless frame. Then, the wireless signal processing unit 260 extracts the MAC frame from the wireless frame, and transmits the MAC frame to MAC frame processing unit 230.

The wireless signal processing units 270 and 280 perform processing similar to the wireless signal processing unit 260. Therefore, description of the wireless signal processing units 270 and 280 is omitted. In the present example, the wireless signal processing units 260, 270, and 280 handle the wireless signals of the 6 GHz band, the 5 GHz band, and the 2.4 GHz band, respectively. Note that the wireless signal processing units 260, 270, and 280 may use a common antenna or may use individual antennas.

The application execution unit 290 executes an application using the data received from the LLC processing unit 210. The application execution unit 290 sends data to the LLC processing unit 210 or receives data from the LLC processing unit 210 according to the operation of the application. The application execution unit 290 may display information from the application on the display 205. Furthermore, the application execution unit 290 may execute processing according to a user operation on an input interface.

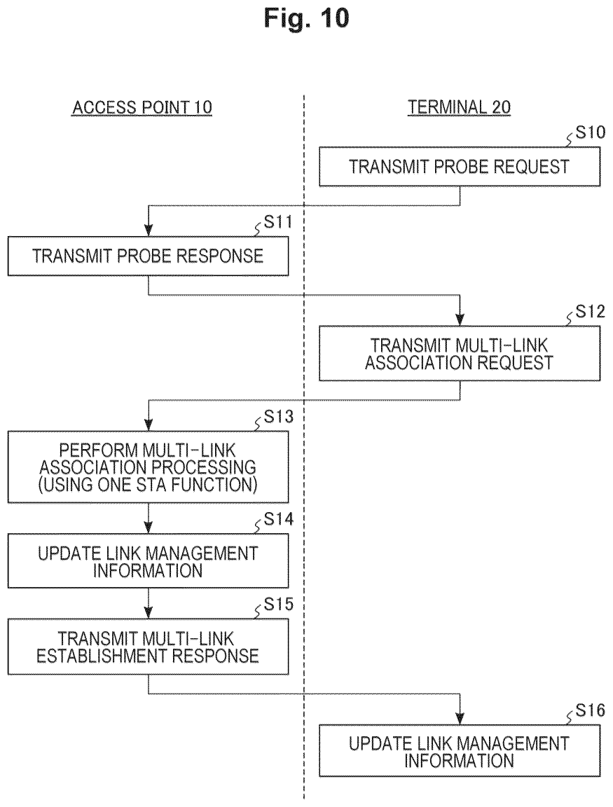

An operation example related to multi-link setup between the access point 10 and the terminal 20 will be described with reference to FIG. 10. The multi-link setup is performed using the management frame.

In step S10, the terminal 20 transmits (broadcasts) a probe request. The probe request is a signal for confirming whether a access point exists around the terminal 20. When receiving the probe request from the terminal 20, the access point 10 executes processing of step S11.

In step S11, the access point 10 transmits a probe response to the terminal 20. The probe response is a signal used by the access point 10 to respond to the probe request from the terminal 20. When receiving the probe response from the access point 10, the terminal 20 executes the processing of step S12. Here, the probe response includes information necessary for establishing a multi-link.

In step S12, the terminal 20 transmits an association request to the access point 10 via any of the STA functions of the terminal 20. The association request includes a signal for requesting the access point 10 to establish a multi-link. For example, the association request is generated by the management unit 240 of the terminal 20. When receiving the association request including the signal for requesting establishment of a multi-link, the management unit 140 of the access point 10 executes processing of step S13. Note that, as the association request, a normal association request to which information for multi-link connection is added may be used.

In step S13, the management unit 140 of the access point 10 executes multi-link association processing using one STA function. Specifically, first, the access point 10 executes association processing of the first STA function with the terminal 20. Then, when a link is established in the first STA function, the management unit 140 of the access point 10 executes association processing of the second STA function using the first STA function for which the link has been established. That is, the STA function with an established link is used for association processing of the STA function with no established link. When the association processing of the at least two STA functions is completed, the access point 10 recognizes that the multi-link with the terminal 20 has been established, and executes processing of step S14.

In step S14, the management unit 140 of the access point 10 updates the link management information 141.

In step S15, the access point 10 transmits a multi-link establishment response to the terminal 20. The multi-link establishment response is a signal used for a response to the multi-link request. When receiving the multi-link establishment response from the access point 10, the management unit 240 of the terminal 20 recognizes that the multi-link with the access point 10 has been established, and executes processing of step S16.

In step S16, the management unit 240 of the terminal 20 updates the link management information 241.

The link management information is updated in both the access point 10 and the terminal 20, whereby the multi-link setup is completed. Thereafter, data communication using the multi-link becomes possible between the access point 10 and the terminal 20.

Here, in the example illustrated in FIG. 10, the connection processing for establishing a multi-link is performed after the probe request from the terminal 20 and the probe response from the access point 10. Alternatively, the access point 10 may periodically transmit a beacon, and the terminal 20 that has received the beacon may transmit the association request for establishing a multi-link, thereby performing the connection processing for establishing a multi-link.

Next, an operation of controlling the use of a multi-link will be described. Here, it is assumed that the PER is used as the communication quality index. Instead of the PER, the collision rate divided by airtime or the RTS retransmission rate may be used.

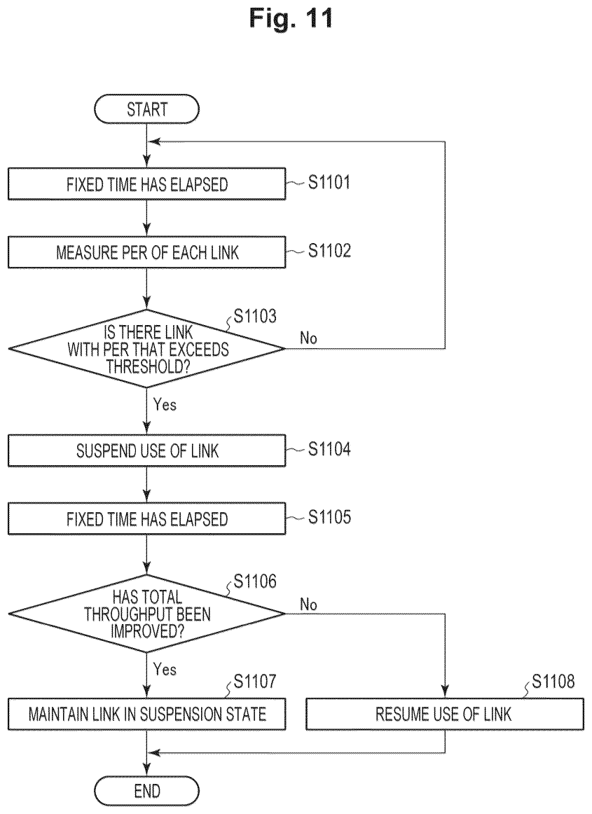

FIG. 11 schematically illustrates an example method for controlling a multi-link, which is executed by the access point 10. The flow illustrated in FIG. 11 may be started when the multi-link setup illustrated in FIG. 10 is completed. In the case where the multi-link is established between the access point 10 and a plurality of terminals, the flow illustrated in FIG. 11 is executed for each terminal.

Here, a method of controlling the multi-link between the access point 10 and the terminal 20 will be described. The multi-link between the access point 10 and the terminal 20 includes three links: a first link, a second link, and a third link, all of which are used for data transmission.

As illustrated in FIG. 11, when a predetermined time has elapsed (step S1101), the processing proceeds to step S1102.

In step S1102, the measurement unit 144 measures the PER for each of the plurality of links included in the multi-link. For example, the measurement unit 144 obtains a measurement result including a first measured value that is a measured value of the PER for the first link, a second measured value that is a measured value of the PER for the second link, and a third measured value that is a measured value of the PER for the third link.

In step S1103, the multi-link control unit 145 determines whether there is a link with the PER that exceeds a predetermined PER threshold. For example, the multi-link control unit 145 determines whether the maximum measured value of the measured values of the PERs exceeds the PER threshold. For example, in a case where the first measured value is higher than the second measured value and the second measured value is higher than the third measured value, the multi-link control unit 145 determines whether the first measured value exceeds the PER threshold. The multi-link control unit 145 determines that there is a link with the PER that exceeds the PER threshold in a case where the maximum measured value exceeds the PER threshold, and determines that there is no link with the PER that exceeds the PER threshold in a case where the maximum measured value is equal to or less than the PER threshold. In the case where there is no link with the PER that exceeds the PER threshold (step S1103; No), the processing returns to step S1101. In the case where there is a link with the PER that exceeds the PER threshold (step S1103; Yes), the processing proceeds to step S1104.

In step S1104, the multi-link control unit 145 suspends the use of the link with the PER that exceeds the PER threshold. For example, the multi-link control unit 145 determines to suspend the use of the link having the maximum measured value of the PER and with the PER that exceeds the PER threshold, and updates the link management information 141 in order to switch the link to the suspension state. Furthermore, the notification unit 146 notifies the terminal 20 of the suspension of the use of the link. The notification unit 146 may transmit the multi-link control information indicating the link to suspend the use to the terminal 20 by using any of the wireless signal processing units 160, 170, and 180. For example, in a case where the first measured value is higher than the second measured value and the third measured value and exceeds the PER threshold, the multi-link control unit 145 determines to suspend the use of the first link. Then, the multi-link control unit 145 updates the link management information 141 in order to switch the first link to the suspension state, and the notification unit 146 notifies the terminal 20 of the suspension of the use of the first link. When receiving the notification from the access point 10, the multi-link control unit 245 of the terminal 20 specifies the link to suspend the use on the basis of the notification, and updates the link management information 241 in order to switch the specified link to the suspension state.

When a predetermined time has elapsed since the execution of the processing of step S1104 (step S1105), the multi-link control unit 145 determines whether a total throughput has been improved in step S1106. The total throughput may be a total throughput related to data transmission between the access point 10 and the terminal 20, that is, a total of the throughputs related to data transmission by the links established between the access point 10 and the terminal 20. In addition, the total throughput may be a total throughput related to data transmission between the access point 10 and all the terminals wirelessly connected to the access point 10, that is, a total of the throughputs related to data transmission by the links established between the access point 10 and all the terminals wirelessly connected to the access point 10. For example, the multi-link control unit 145 compares the total throughput before the link suspension with the total throughput after the link suspension in order to determine whether the total throughput has been improved. For example, in a case where the total throughput after the link suspension exceeds the total throughput before the link suspension, the multi-link control unit 145 determines that the total throughput has been improved, and otherwise, determines that the total throughput has not been improved. In place of or in addition to the total throughput, the multi-link control unit 145 may determine whether the latency related to data transmission between the access point 10 and the terminal 20 has been improved. Alternatively, the multi-link control unit 145 may determine whether the Ack response rate related to data transmission between the access point 10 and the terminal 20 has been improved.

In the case where the total throughput has been improved (step S1106; Yes), the processing proceeds to step S1107. In step S1107, the multi-link control unit 145 maintains the link in the suspension state.

In a case where the total throughput has not been improved (step S1106; No), the processing proceeds to step S1108. In step S1108, the multi-link control unit 145 resumes the use of the link that has been put into the suspension state. For example, the multi-link control unit 145 updates the link management information 141 in order to switch the first link to the active state. Further, the notification unit 146 notifies the terminal 20 of the resumption of the use of the first link. When receiving the notification from the access point 10, the multi-link control unit 245 of the terminal 20 specifies the link to resume the use on the basis of the notification, and updates the link management information 241 in order to switch the specified link to the active state.

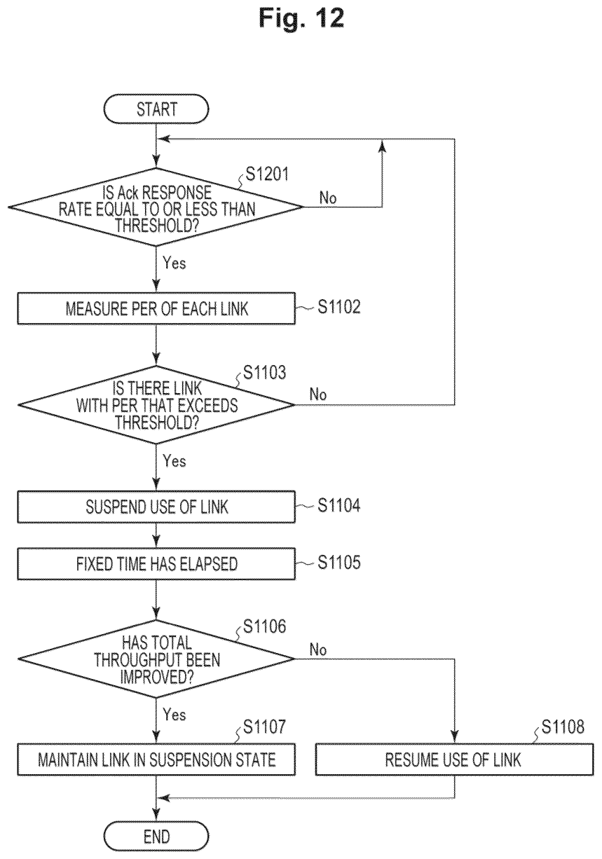

FIG. 12 schematically illustrates another example of the method for controlling a multi-link, which is executed by the access point 10. In FIG. 12, steps similar to those illustrated in FIG. 11 are denoted by similar reference numerals, and description thereof is omitted. The flow illustrated in FIG. 12 is obtained by changing step S1101 to step S1201 in the flow illustrated in FIG. 11.

In step S1201 of FIG. 12, the measurement unit 144 measures the Ack response rate of the terminal 20 over a predetermined period, and compares the Ack response rate with a predetermined Ack response rate threshold. In a case where a measured value of the Ack response rate exceeds the Ack response rate threshold (step S1201; No), the processing of step S1201 is repeated. In a case where the measured value of the Ack response rate is equal to or less than the Ack response rate threshold (step S1201; Yes), the processing proceeds to step S1102. Since the processing of and after step S1102 has been described with reference to FIG. 11, description thereof is omitted here.

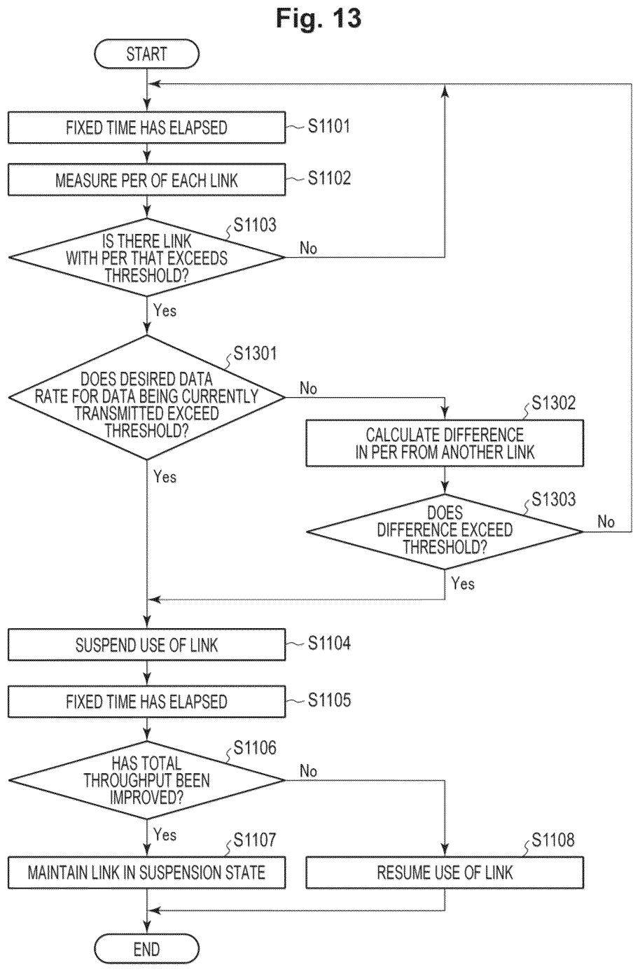

FIG. 13 schematically illustrates another example of the method for controlling a multi-link, which is executed by the access point 10. In FIG. 13, steps similar to those illustrated in FIG. 11 are denoted by similar reference numerals, and description thereof is omitted. The flow illustrated in FIG. 13 is obtained by adding steps S1301 to S1303 to the flow illustrated in FIG. 11. steps S1301 to S1303 are added between steps S1103 and S1104.

In the example illustrated in FIG. 13, in a case where there is a link with the PER that exceeds the PER threshold (step S1103; Yes), the processing proceeds to step S1301. In step S1301, the multi-link control unit 145 determines whether a desired data rate for the data transmitted to the terminal 20 using the link with the PER that exceeds the PER threshold exceeds a predetermined desired data rate threshold. The desired data rate represents a data rate desired for the data. For example, for data generated from a real-time application, a higher desired data rate is set than for data generated from an application for which real-time property is not required.

In a case where the desired data rate exceeds the desired data rate threshold (step S1301; Yes), the processing proceeds to step S1104. In step S1104, the multi-link control unit 145 suspends the use of the link with the PER determined to exceed the PER threshold in step S1103.

In a case where the desired data rate does not exceed the desired data rate threshold (step S1301; No), the processing proceeds to step S1302. In step S1302, the multi-link control unit 145 calculates a difference between the PER of the link with the PER determined to exceed the PER threshold in step S1103 and the PER of another link. Specifically, the multi-link control unit 145 calculates the difference by subtracting the PER of another link from the PER of the link with the PER determined to exceed the PER threshold in step S1103.

In step S1303, the multi-link control unit 145 determines whether the difference calculated in step S1302 exceeds a predetermined difference threshold. In a case where the calculated difference does not exceed the difference threshold (step S1302; No), the processing returns to step S1101. In a case where the calculated difference exceeds the difference threshold (step S1302; Yes), the processing proceeds to step S1104. In step S1104, the multi-link control unit 145 suspends the use of the link with the PER determined to exceed the PER threshold in step S1103.

Referring back to the case referred to in the description of FIG. 11, the multi-link control unit 145 determines whether the first measured value exceeds the PER threshold (step S1103). In a case where the first measured value exceeds the PER threshold, the multi-link control unit 145 determines whether the desired data rate for the data being transmitted to the terminal 20 using the first link exceeds the desired data rate threshold (step S1301). In the case where the desired data rate exceeds the desired data rate threshold, the multi-link control unit 145 suspends the use of the first link (step S1104).

In the case where the desired data rate does not exceed the desired data rate threshold, the multi-link control unit 145 calculates a difference obtained by subtracting the second measured value from the first measured value (step S1302). The multi-link control unit 145 suspends the use of the first link in response to the calculated difference exceeding the difference threshold (step S1104).

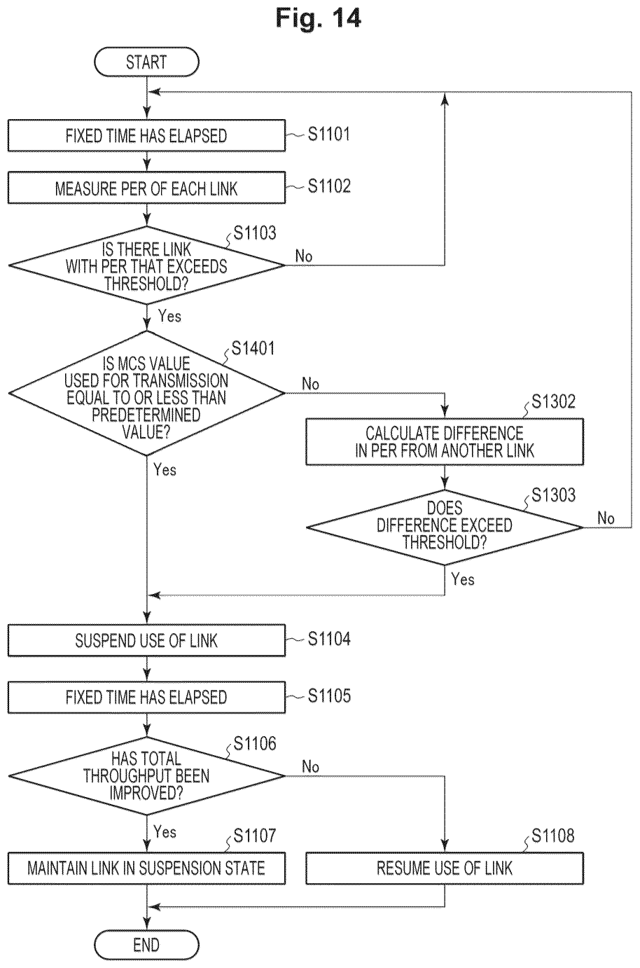

FIG. 14 schematically illustrates another example of the method for controlling a multi-link, which is executed by the access point 10. In FIG. 14, steps similar to those illustrated in FIGS. 11 and 13 are denoted by similar reference numerals, and description thereof is omitted. The flow illustrated in FIG. 14 is obtained by changing step S1301 to step S1401 in the flow illustrated in FIG. 13.

In the example illustrated in FIG. 14, in the case where there is a link with the PER that exceeds the PER threshold (step S1103; Yes), the processing proceeds to step S1401. In step S1401, the multi-link control unit 145 determines whether an MCS value for specifying a modulation and coding scheme (MCS) used for data transmission on the link with the PER that exceeds the PER threshold is equal to or less than a predetermined MCS threshold. The MCS value is information for specifying a combination of a modulation scheme and an error correction coding rate. For example, IEEE 802.11ax defines twelve types of MCSs from MCS0 to MCS11. As the MCS value is higher, data can be transmitted at a higher data rate. For example, the MCS value is selected so as to satisfy the desired data rate. The MCS value is also referred to as an MCS index.

In a case where the MCS value is equal to or less than the MCS threshold (step S1401; Yes), the processing proceeds to step S1104, and the multi-link control unit 145 suspends the use of the link with the PER determined to exceed the PER threshold in step S1103.

In a case where the MCS value exceeds the MCS threshold (step S1401; No), the processing proceeds to step S1302. Since the processing of and after step S1302 has been described with reference to FIGS. 10 and 12, description thereof is omitted here.

Referring back to the case referred to in the description of FIG. 11, the multi-link control unit 145 determines whether the MCS value used in the first link is equal to or less than the MCS threshold (step S1401). In a case where the MCS value used in the first link is equal to or less than the MCS threshold, the multi-link control unit 145 suspends the use of the first link (step S1104). In the case where the MCS value exceeds the threshold, the multi-link control unit 145 calculates the difference obtained by subtracting the second measured value from the first measured value (step S1302). The multi-link control unit 145 suspends the use of the first link in the case where the calculated difference exceeds the difference threshold (step S1104).

In FIG. 13 or 14, the processing in step S1101 may be replaced with the processing in step S1201 illustrated in FIG. 12.

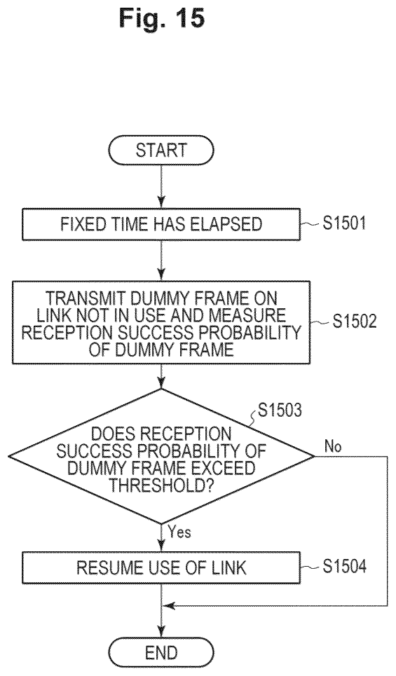

FIG. 15 schematically illustrates another example of the method for controlling a multi-link, which is executed by the access point 10. Specifically, FIG. 15 schematically illustrates an example of a method of resuming the use of the link in the suspension state among the links forming the multi-link between the access point 10 and the terminal 20. Here, it is assumed that one link is transitioned to the suspension state on the basis of the control flows as illustrated in FIGS. 11 to 14. The flow illustrated in FIG. 15 can be executed, for example, after the control flow illustrated in any of FIGS. 11 to 14 ends. Note that the link may transition to the suspension state for some other reasons.

As illustrated in FIG. 15, when a predetermined time has elapsed (step S1501), the processing proceeds to step S1502.

In step S1502, the multi-link control unit 145 transmits the dummy frame to the terminal 20 using the link in the suspension state, and the measurement unit 144 measures the reception success probability of the dummy frame. For example, the multi-link control unit 145 generates a predetermined number of MAC frames including dummy data. Then, the multi-link control unit 145 sends these MAC frames to the MAC frame processing unit 130, and instructs the MAC frame processing unit 130 to transmit these MAC frames using the link in the suspension state. To transmit a predetermined number of MAC frames, the MAC frame processing unit 130 repeats processing including execution of carrier sense and transmission of the MAC frame. The measurement unit 144 measures a ratio of the MAC frames successfully received by the terminal 20 to the predetermined number of MAC frames as the reception success probability of the dummy frame.

In step S1503, the multi-link control unit 145 determines whether the reception success probability of the dummy frame exceeds a predetermined probability threshold.

In a case where the reception success probability of the dummy frame does not exceed the probability threshold (step S1503; No), the processing ends. The flow illustrated in FIG. 15 may be executed again immediately after the end of the processing. Alternatively, the flow illustrated in FIG. 15 may be executed again after a predetermined time elapses after the end of the processing.

In a case where the reception success probability of the dummy frame exceeds the probability threshold (step S1503; Yes), the processing proceeds to step S1504. In step S1504, the multi-link control unit 145 resumes the use of the link in the suspension state. For example, the multi-link control unit 145 updates the link management information 141 in order to switch the link to the active state. Further, the notification unit 146 transmits the multi-link control information indicating the link to resume the use to the terminal 20.

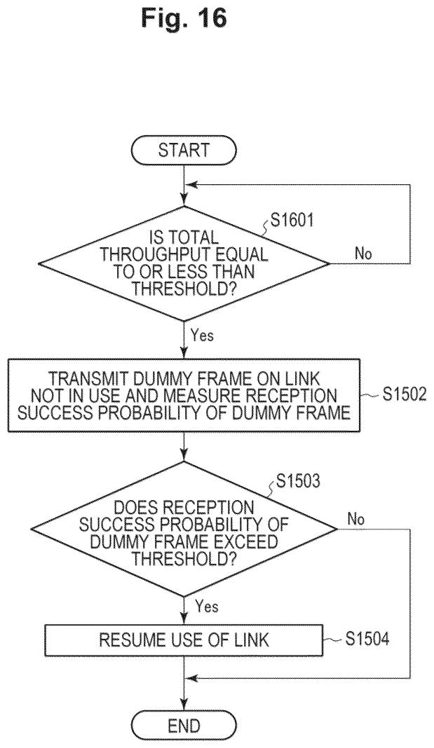

FIG. 16 schematically illustrates another example of the method of resuming the use of the link in the suspension state among the links forming the multi-link between the access point 10 and the terminal 20. In FIG. 16, steps similar to those illustrated in FIG. 15 are denoted by similar reference numerals, and description thereof is omitted. The flow illustrated in FIG. 16 is obtained by changing step S1501 to step S1601 in the flow illustrated in FIG. 15.

In step S1601 of FIG. 16, the multi-link control unit 145 determines whether the total throughput related to the data transmission between the access point 10 and the terminal 20 is equal to or less than a predetermined throughput threshold. Instead of or in addition to the total throughput, the latency or the Ack response rate related to data transmission between the access point 10 and the terminal 20 may be used.

In a case where the total throughput exceeds the throughput threshold (step S1601; No), the processing of step S1601 is repeated.

In a case where the total throughput is equal to or less than the throughput threshold (step S1601; Yes), the processing proceeds to step S1502. Since the processing of and after step S1502 has been described with reference to FIG. 15, description thereof is omitted here.

Note that the flow illustrated in FIG. 15 and the flow illustrated in FIG. 16 can be combined. Specifically, in FIG. 15, step S1601 may be provided between step S1501 and step S1502. In this case, in the case where the total throughput exceeds the throughput threshold, the processing returns to step S1501.

As described above, the access point 10 measures the communication quality index for each of a plurality of links forming the multi-link between the access point 10 and the terminal 20, and determines whether to suspend the use of the link having the largest communication quality index (that is, the lowest communication quality) on the basis of comparison between the largest communication quality index and a predetermined communication quality index threshold. According to this configuration, it is possible to avoid the use of the link with low communication quality, such as a link in a situation where a frame collision is likely to occur. As a result, it is possible to prevent deterioration of the communication characteristics of the multi-link communication.

As the communication quality index, an index with a value that becomes larger as the communication quality is lower may be used. For example, the communication quality index may include at least one of the packet error rate, the frame collision rate divided by airtime, or the RTS retransmission rate. Each of these indexes increases in value in a case where a hidden terminal is present, for example. The access point 10 determines a link with the communication quality index that exceeds the communication quality index threshold as a link in which many frame collisions occur, and suspends the use of the link. According to this configuration, it is possible to suspend the use of the link in the situation where a frame collision is likely to occur. As a result, deterioration of the communication characteristics of the multi-link communication can be prevented.

The access point 10 may suspend the use of the link having the largest communication quality index in response to the fact that the largest communication quality index exceeds the communication quality index threshold, and the fact that the desired data rate for the data being transmitted to the terminal 20 by using the link having the largest communication quality index exceeds the predetermined desired data rate threshold. According to this configuration, it is possible to avoid transmission of large capacity data (for example, data requiring transmission with a high MCS value) in the link with low communication quality such as the link in the situation where a frame collision is likely to occur.

The access point 10 may calculate a difference between the largest communication quality index and the second largest communication quality index in a case where the largest communication quality index exceeds the communication quality index threshold and the desired data rate for the data being transmitted to the terminal 20 using the link having the largest communication quality index does not exceed the desired data rate threshold. The access point 10 may suspend the use of the link having the largest communication quality index in response to the calculated difference exceeding the predetermined difference threshold. The calculated difference exceeding the difference threshold indicates that the communication quality of one link is extremely low. According to this configuration, it is possible to avoid the use of the link having extremely low communication quality.

The access point 10 may suspend the use of the link having the largest communication quality index in response to the fact that the largest communication quality index exceeds the communication quality index threshold and the fact that the MCS value used for data transmission on the link having the largest communication quality index falls below a predetermined MCS threshold. According to this configuration, it is possible to avoid the use of a link having a large number of transmission failures despite the low transmission rate, that is, a link having many interferences.

The access point 10 may calculate the difference between the largest communication quality index and the second largest communication quality index in a case where the largest communication quality index exceeds the communication quality index threshold and the MCS value used for data transmission on the link having the largest communication quality index exceeds the MCS threshold. The access point 10 may suspend the use of the link having the largest communication quality index in response to the calculated difference exceeding the predetermined difference threshold. According to this configuration, it is possible to avoid the use of the link having extremely low communication quality.

The access point 10 may continue the suspension of the use of the link in a case where the total throughput, latency, or Ack response rate for data transmission between the access point 10 and the terminal 20 has been improved after the suspension of the use of the link, and may resume the use of the link in a case where the total throughput, latency, or Ack response rate for data transmission between the access point 10 and the terminal 20 is not improved after the suspension of the use of the link. According to this configuration, it is possible to cancel the suspension in the case where the communication characteristics of the multi-link communication are not improved even if the use of the link is suspended.

After the use of the link is suspended, the access point 10 may send the dummy frame to the terminal 20 by using the link, and resume the use of the link in response to the reception success probability of the dummy frame exceeding the probability threshold. According to this configuration, it is possible to resume the use of the link that has gotten away from the situation where a frame collision is likely to occur.

### Modification

In the above-described embodiment, the access point 10 measures the index related to the communication quality or performance of a link for each terminal and for each link.

In another embodiment, each terminal may perform measurement instead of or in addition to the access point 10. For example, the management unit 240 of the terminal 20 includes a measurement unit that measures at least one type of index related to communication quality or performance of a link for each of a plurality of links forming a multi-link between the terminal and the access point 10. The at least one type of index to be measured includes a communication quality index representing the communication quality of the link. The communication quality index may be a PER, a collision rate divided by airtime, or an RTS retransmission rate. In this case, for example, the PER represents a ratio of frames that cannot be received by the access point 10 to frames transmitted to the access point 10 by the terminal 20. The management unit 240 of the terminal 20 may include a measurement result transmission unit that transmits a measurement result obtained by the measurement unit to the access point 10. The transmission of the measurement result may be performed using a management frame. In this case, the management unit 140 of the access point 10 includes a measurement result reception unit that receives the measurement result from the terminal, and the multi-link control unit 145 of the management unit 140 performs multi-link control on the basis of the measurement result received by the measurement result reception unit.

In this manner, the access point 10 acquires the index related to the communication quality or performance of the link by measuring the index and/or receiving the measurement result of the index from the terminal.

In the above-described embodiment, as the communication quality index, an index with a value that becomes larger as the communication quality of the link is lower is used. In another embodiment, as the communication quality index, an index with a value that becomes smaller as the communication quality of the link is lower may be used.

The wireless communication function included in the wireless stations (the access point 10 and the terminal 20) may be implemented by a discrete component such as a chip. For example, a chip may be incorporated into a substrate of the wireless station at the time of manufacturing the wireless station. A wireless apparatus mentioned herein may refer to a wireless station, or may refer to a discrete component that forms the wireless communication function of the wireless station.

Note that the present invention is not limited to the above-described embodiment and various modifications may be made in the implementation stage without departing from the gist of the invention. The embodiments may be implemented in appropriate combinations, and combined advantageous effects in these cases can be obtained. Further, the foregoing embodiments includes various inventions, and various inventions can be extracted by a combination selected from a plurality of disclosed constituents. For example, when the problems can be solved and the advantageous effects can be obtained even if some constituents are deleted from all the constituents described in the embodiment, configurations from which the constituents are deleted can be extracted as inventions.

Reference Signs List

10 Access point
20 Terminal
30 Server
40 Communication network
45 Wireless network
50 Communication system
101 CPU
102 Program memory
103 RAM
104 Wireless communication module
105 Wired communication module
110 LLC processing unit
120 Data processing unit
130 MAC frame processing unit
131 Classification unit
132A, 132B, 132C, 132D, 132E Transmission queue
133A, 133B, 133C, 133D, 133E Carrier sense execution unit
134 Collision management unit
140 Management unit
141 Link management information
142 Association processing unit
143 Authentication processing unit
144 Measurement unit
145 Multi-link control unit
146 Notification unit
150 Link management unit
160, 170, 180 Wireless signal processing unit
201 CPU
202 Program memory
203 RAM
204 Wireless communication module
205 Display
206 Storage
210 LLC processing unit
220 Data processing unit
230 MAC frame processing unit
240 Management unit
241 Link management information
242 Association processing unit
243 Authentication processing unit
244 Multi-link control information acquisition unit
245 Multi-link control unit
250 Link management unit
260, 270, 280 Wireless signal processing unit
290 Application execution unit

1. A wireless apparatus comprising:
circuitry configured to:
acquire a communication quality index indicating communication quality of a link for each of a plurality of links forming a multi-link with another wireless apparatus; and
determine whether to suspend use of a first link having a lowest communication quality among the plurality of links based on comparison between the communication quality index for the first link and a first threshold.

2. The wireless apparatus according to claim 1, wherein the communication quality index includes at least one of a packet error rate, a collision rate divided by Air time, or a retransmission rate of request to send (RTS).

3. The wireless apparatus according to claim 1, wherein the circuitry is configured to suspend the use of the first link in response to the communication quality index for the first link exceeding the first threshold.

4. The wireless apparatus according to claim 3, wherein the circuitry is configured to suspend the use of the first link in response to the communication quality index for the first link exceeding the first threshold and a desired data rate for data being transmitted to another wireless apparatus using the first link exceeding a second threshold.

5. The wireless apparatus according to claim 4, wherein the circuitry is configured to calculate a difference between the communication quality index for the first link and the communication quality index for a second link included in the plurality of links when the communication quality index for the first link exceeds the first threshold and the desired data rate is equal to or less than the second threshold, and suspend the use of the first link in response to the calculated difference exceeding a third threshold.

6. The wireless apparatus according to claim 3, wherein the circuitry is configured to suspend the use of the first link in response to the communication quality index for the first link exceeding the first threshold and a modulation and coding scheme (MCS) value specifying an MCS used for data transmission on the first link falling below a second threshold.

7. The wireless apparatus according to claim 6, wherein the circuitry is configured to calculate a difference between the communication quality index for the first link and the communication quality index for a second link included in the plurality of links when the communication quality index for the first link exceeds the first threshold and the MCS value exceeds the second threshold, and suspend the use of the first link in response to the calculated difference exceeding a third threshold.

8. The wireless apparatus according to claim 1, wherein the circuitry is configured to continue the suspension of the use of the first link when a total throughput, a latency, or an Ack response rate regarding data transmission between the wireless apparatus and another wireless apparatus is improved after the suspension of the use of the first link, or resume the use of the first link when the total throughput, the latency, or the Ack response rate regarding data transmission between the wireless apparatus and another wireless apparatus is not improved after the suspension of the use of the first link.

9. The wireless apparatus according to claim 1, wherein the circuitry is further configured to transmit a dummy frame to another wireless apparatus using the first link after the suspension of the use of the first link, and wherein
the circuitry is configured to resume the use of the first link in response to a reception success probability of the dummy frame exceeding a fourth threshold.

10. A wireless communication method executed by a wireless apparatus, the method comprising:
acquiring a communication quality index indicating communication quality of a link for each of a plurality of links forming a multi-link with another wireless apparatus; and
determining whether to suspend use of a first link having the lowest communication quality among the plurality of links based on comparison between the communication quality index for the first link and a first threshold.
